(19) United States
(12) Patent Application Publication
(10) Pub. No.: US 2025/0086636 A1
(43) Pub. Date: Mar. 13, 2025

(54) ANOMALY DETECTION SYSTEM FOR MOBILE PAYMENT FUND TRANSFERS

(71) Applicant: Visa International Service Association, San Francisco, CA (US)

(72) Inventors: Yee En Geowynn Teoh, Singapore (SG); Lubna Akhtar, Singapore (SG); Dibyajyoti Sen, Lake Gardens, Kolkata (IN); Leon Darmanto Rais, Singapore (SG); Arunima Banerjee

(73) Assignee: Visa International Service Association, San Francisco, CA (US)

(21) Appl. No.: 18/463,027

(22) Filed: Sep. 7, 2023

(51) Int. Cl. G06Q 20/40; G06Q 20/32

(52) U.S. Cl. CPC G06Q 20/4016; G06Q 20/3223

(57) ABSTRACT

The present disclosure generally relates to an anomaly detection solution using advanced mobile payments data and mobile transaction-level features to help banks detect potential anomalous behavior in their mobile banking platform. The solution disclosed in the present disclosure is embedded into a broader fraud and anomaly detection monitoring framework at client end to make real time decisions on transaction approval, hold, or decline. This leads to reduced fraud losses and exposures, and optimized transaction approval rates for the client. As opposed to typical models deployed by banks which are unique and targeted to a specific use, this solution concurrently caters to three distinct use cases: detection of potential fraudulent activity, facility abuse by client, and potential laundering activity.

### TECHNICAL FIELD

The following disclosure relates generally to an anomaly detection system that allows for effective detection of fraudulent and anomalous mobile payment fund transfers by introducing risk mitigation across several distinct transaction risk elements on mobile payments.

### SUMMARY

In one aspect, the present disclosure provides a system for detecting anomalies in mobile payment transactions, the system including a server computer including a processor and a memory coupled to the processor, the memory storing thereon machine executable instructions that when executed cause the processor to monitor mobile payment transactions in real time, determine account related attributes or relationship related attributes of the mobile payment transactions, identify anomalous behavior in a current mobile payment transaction by clustering the account related attributes or relationship related attributes by an unsupervised statistical algorithm, generate a preliminary transaction anomaly score based on the identified anomalous behavior of the current mobile payment transaction, augment the preliminary transaction anomaly score with a rule-based framework to generate a final transaction anomaly score, and recommend an action for the current mobile payment transaction based on the final transaction anomaly score.

In one aspect of the system, the unsupervised statistical algorithm combines account dimension data, account metrics data, and account type data to obtain a comprehensive data set relating to the account related attributes, the account dimension data includes information relating to at least one of an account type, transaction time, transaction date, transaction currency, or a transfer channel; the account metrics data includes information relating to at least one of a transaction amount, transaction count, ratio of incoming transfers to outgoing transfers, variance between a minimum transfer amount and a maximum transfer amount, recent transaction trends, or a percentage of funds being transferred; and the account type data includes information relating to at least one of a source account or a destination account.

In one aspect of the system, the unsupervised statistical algorithm combines relationship metrics data and relationship type data to obtain a comprehensive data set relating to the relationship related attributes, the relationship metrics data includes information relating to at least one of a number of days since a first transaction, a number of days since a last transaction, a number of transactions in a previous month, a number of transactions in a previous three months, a number of transactions in a previous six months, a total transaction amount in the previous month, a total transaction amount in the previous three months, and a total transaction amount in the previous six months; and relationship type data includes information relating to at least one of a source account or a destination account.

In one aspect of the system, the identified anomalous behavior is at least one of a fraudulent activity, client abuse activity, or potential laundering activity.

In one aspect of the system, the system further includes a three-layer framework including a probabilistic model to generate the preliminary transaction anomaly score; a rule-based framework used to augment the preliminary transaction anomaly score according to recent market and portfolio fraud trends; and a decision engine to approve, refer, or decline the mobile payment transactions based on a comparison between the final transaction anomaly score and a scoring threshold.

In one aspect of the system, both the probabilistic model and the rule-based framework are used for intrabank transfers, and only the rule-based framework is used for interbank transfers.

In one aspect of the system, customer data from an issuer is used to more accurately model behavior for regular transfers and anomalous transfers.

In one aspect of the system, a graph visualization tool is used to investigate high score transactions and create a feedback loop for fine tuning the system.

In one aspect of the system, graph embeddings are used to project mobile payment transactions onto a 3D plane, and transaction volume and transaction frequency are properties of each node of the graph embeddings.

In one aspect of the system, a location of a payment device is geo-spatially mapped onto a map to create grids over time that model customer behavior for regular transfers and anomalous transfers.

A processor-implemented method for detecting anomalies in mobile payment transactions, the method including monitoring mobile payment transactions in real-time, determining account related attributes or relationship related attributes of the mobile payment transactions, identifying anomalous behavior in a current mobile payment transaction by clustering the account related attributes or relationship related attributes by an unsupervised statistical algorithm, generating a preliminary transaction anomaly score based on the identified anomalous behavior of the current mobile payment transaction, augmenting the preliminary transaction anomaly score with a rule-based framework to generate a final transaction anomaly score, and recommending an action for the current mobile payment transaction based on the final transaction anomaly score.

In one aspect of the processor-implemented method, the unsupervised statistical algorithm combines account dimension data, account metrics data, and account type data to obtain a comprehensive data set relating to the account related attributes, the account dimension data includes information relating to at least one of an account type, transaction time, transaction date, transaction currency, or a transfer channel; the account metrics data includes information relating to at least one of a transaction amount, transaction count, ratio of incoming transfers to outgoing transfers, variance between a minimum transfer amount and a maximum transfer amount, recent transaction trends, or a percentage of funds being transferred; and the account type data includes information relating to at least one of a source account or a destination account.

In one aspect of the processor-implemented method, the unsupervised statistical algorithm combines relationship metrics data and relationship type data to obtain a comprehensive data set relating to the relationship related attributes, the relationship metrics data includes information relating to at least one of a number of days since a first transaction, a number of days since a last transaction, a number of transactions in a previous month, a number of transactions in a previous three months, a number of transactions in a previous six months, a total transaction amount in the previous month, a total transaction amount in the previous three months, and a total transaction amount in the previous six months; and relationship type data includes information relating to at least one of a source account or a destination account.

In one aspect of the processor-implemented method, the identified anomalous behavior is at least one of a fraudulent activity, client abuse activity, or potential laundering activity.

In one aspect of the processor-implemented method, the method further includes using a three-layer framework including a probabilistic model to generate the preliminary transaction anomaly score; a rule-based framework used to augment the preliminary transaction anomaly score according to recent market and portfolio fraud trends; and a decision engine to approve, refer, or decline the mobile payment transactions based on a comparison between the final transaction anomaly score and a scoring threshold.

In one aspect of the processor-implemented method, both the probabilistic model and the rule-based framework are used for intrabank transfers, and only the rule-based framework is used for interbank transfers.

In one aspect of the processor-implemented method, customer data from an issuer is used to more accurately model behavior for regular transfers and anomalous transfers.

In one aspect of the processor-implemented method, a graph visualization tool is used to investigate high score transactions and create a feedback loop for fine tuning a system.

In one aspect of the processor-implemented method, graph embeddings are used to project mobile payment transactions onto a 3D plane, and transaction volume and transaction frequency are properties of each node of the graph embeddings.

In one aspect of the processor-implemented method, a location of a payment device is geo-spatially mapped onto a map to create grids over time that model customer behavior for regular transfers and anomalous transfers.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a layered framework used for intra-bank and inter-bank transfers, according to at least one aspect of the present disclosure.

FIG. 2 is a bubble diagram illustrating customer data accessible from an issuer that is used to model behavior for mobile payment fund transfers, according to at least one aspect of the present disclosure.

FIG. 3 is an example graph embedding for account-related attributes that projects a source to destination account mobile payment fund transfer flow onto a 3D plane using transaction volume and frequency as properties of the node, according to at least one aspect of the present disclosure.

FIG. 4 is an example graph embedding for relationship-related attributes that projects a source to destination account mobile payment fund transfer flow onto a 3D plane using transaction volume and frequency as properties of the node, according to at least one aspect of the present disclosure.

FIG. 5 is a flow diagram showing a typical data science flow for a generative probabilistic model on mobile payment transactions, according to at least one aspect of the present disclosure.

FIGS. 6A-C illustrate an “Isolation Forest” tree-based method to measure how easily points can be separated by randomly splitting the data into smaller regions, according to at least one aspect of the present disclosure.

FIGS. 7A-B illustrate a “K-Means” distance-based method to measure how far a point is located from its neighbors and cluster centroids, according to at least one aspect of the present disclosure.

FIG. 8 illustrates a “Gaussian Mixture” distance-based method to measure how far a point is located from its neighbors and cluster centroids, according to at least one aspect of the present disclosure.

FIG. 9 illustrates a sample group from a graph embedding that includes a first account, a second account, and a third account, according to at least one aspect of the present disclosure.

FIGS. 10A-C illustrate a geo-spatial mapping of payment device locations at the time of a transaction in order to create hex grids and model customer behavior for regular and irregular mobile payment transactions, according to at least one aspect of the present disclosure.

FIG. 11 illustrates different levels of resolution for hexagon and pentagon grids created during a geo-spatial mapping of payment device locations at the time of a transaction, according to at least one aspect of the present disclosure.

FIG. 12 illustrates a potential anomalous transaction pattern, such as receiving a fund and immediately transferring the same amount, using a graph visualization tool, Neo4J, according to at least one aspect of the present disclosure.

FIG. 13 illustrates a potential anomalous transaction pattern, such as repeated ticket size transfer to the same account within a short period of time, using a graph visualization tool, Neo4J, according to at least one aspect of the present disclosure.

FIG. 14 illustrates a potential anomalous transaction pattern, such as transaction activity during unusual hours during mid-night, using a graph visualization tool, Neo4J, according to at least one aspect of the present disclosure.

FIG. 15 illustrates a potential anomalous transaction pattern, such as higher than usual ticket size from the same account, using a graph visualization tool, Neo4J, according to at least one aspect of the present disclosure.

FIG. 16 illustrates a potential anomalous transaction pattern, such as a destination account receiving funds from multiple different accounts in a short period of time, using a graph visualization tool, Neo4J, according to at least one aspect of the present disclosure.

FIG. 17 illustrates an implementation of the anomaly detection system using a three-layer framework, according to at least one aspect of the present disclosure.

FIG. 18 illustrates a method for detecting anomalies in mobile payment transactions, according to at least one aspect of the present disclosure.

FIG. 19 is a block diagram of a computer apparatus with data processing subsystems or components, according to at least one aspect of the present disclosure.

FIG. 20 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Before discussing specific embodiments, aspects, or examples, some descriptions of terms used herein are provided below.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device.

As used herein, a “mobile device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may comprise any suitable hardware and software for performing such functions, and may also include multiple devices or components (e.g. when a device has remote access to a network by tethering to another device—e.g., using the other device as a modem-both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below.

As used herein, a “payment account” (which may be associated with one or more payment devices) may refer to any suitable payment account including a credit card account, a checking account, or a prepaid account.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “transaction amount” may be the price assessed to the consumer for the transaction. The transaction amount condition may be a threshold value (e.g., all transactions for an amount exceeding $100) or a range (e.g., all transactions in the range of $25-$50). For example, a user may wish to use a first routing priority list for a transaction for an amount in the range of $0.01-$100 and a second routing priority list for a transaction for an amount exceeding $100.

A “user” may include an individual. In some embodiments or aspects, a user may be associated with one or more personal accounts and/or mobile devices. The user may also be referred to as a cardholder, account holder, or consumer.

A “user device” is an electronic device that may be transported and/or operated by a user. A user device may provide remote communication capabilities to a network. The user device may be configured to transmit and receive data or communications to and from other devices. In some embodiments or aspects, the user device may be portable. Examples of user devices may include mobile phones (e.g., smart phones, cellular phones, etc.), PDAs, portable media players, wearable electronic devices (e.g. smart watches, fitness bands, ankle bracelets, rings, earrings, etc.), electronic reader devices, and portable computing devices (e.g., laptops, netbooks, ultrabooks, etc.). Examples of user devices may also include automobiles with remote communication capabilities.

As of late, mobile banking issuers have been facing an increasing challenge due to a rising number of anomalous transactions occurring within their systems. These anomalous transactions may occur from any user, user account, payment account, and the like. Additionally, these anomalous transactions may occur on any device, or user device, utilizing an electronic wallet, which includes any mobile device utilizing an electronic wallet mobile application. Each of the electronic wallet and electronic wallet mobile application may utilize any suitable server and processor to complete any number of transactions, where the transactions may include any transaction amount. As discussed in greater detail below, the anomaly detection systems disclosed herein generally relate to a transaction amount. A number of additional factors may also affect the anomaly detection system, including, but not limited to, transaction frequency, transaction volume, transaction date/time, transaction pathways, and the like. As will be discussed in greater detail below, these factors may lead to several different types of anomalous transactions that may occur within a mobile banking system. Generally, the anomalous transactions in a mobile banking system that are discussed below can be identified as one of fraudulent activity, client abuse activity, or potential laundering activity. As a result of the rising number of anomalous transactions, mobile banking issuers are challenged to effectively implement risk measures that are able to detect anomalous transactions and protect mobile banking issuers from threats to the security and integrity of their systems.

In order to provide context as to what may be considered an anomalous transaction, or what may be considered either fraudulent activity, client abuse activity, or potential laundering activity, a few examples will be provided herein. First, an example may be a customer who regularly transferred 100.00 USD at a regular time (i.e., regularly receiving 100.00 USD during the day), but then suddenly began transferring a much larger amount of value at strange times (i.e., suddenly receiving 1,000.00 USD, or 10,000.00 USD, in the middle of the night). A second example may be a user that was transferring small value transactions between USD and KHR within their own accounts in order to make small gains on foreign exchange spreads between currencies. A final example may be a customer that begins receiving transactions from multiple new accounts within a short period of time. These are just a few examples of pattern than may be indicative of anomalous activity. Although, a complete determination must be made through analysis. It should be noted that there are countless possible anomalous transactions. The three examples provided above should not, in any way, be construed as limiting the present disclosure. Rather, these examples are intended to illustrate that anomalous transactions may not be as clear, or obvious, as some may think.

The present disclosure generally provides a solution which involves usage of customer-level attributes, such as account related attributes and relationship related attributes, as well as advanced mobile payment data, including geo-location tags and graph embeddings, as inputs for a solution framework to detect potential anomalous transactional behaviors. The solution generally includes identifying transactions that are most likely to be anomalous by scoring each transaction in real-time via a layered framework and comparing to a predefined threshold. The solution further includes the use of account-to-account network structures in order to study anomalous scores and adopt a recursive calibration process due to the unavailability of labelled data. The solution further includes incorporating geo-location features by projecting the latitude and longitude of a payment device for each mobile payment into map areas, or grids, in order to identify the number of transactions and frequency of transactions by an account in each respective area, or grid. The solution further includes using graph embeddings to map the flow of funds between accounts. In this case, the different accounts form various nodes and the relationship between each node (i.e., the number of connections, the distance between each node, etc.) is based on the amount, and frequency, of transactions between the different accounts. The solution further includes using unsupervised statistical techniques to cluster anomalous mobile payments behavior. The solution further includes using a graph visualization tool, such as Neo4J, to provide a holistic view at a customer level and to identify broader transaction patterns across various accounts and/or customers.

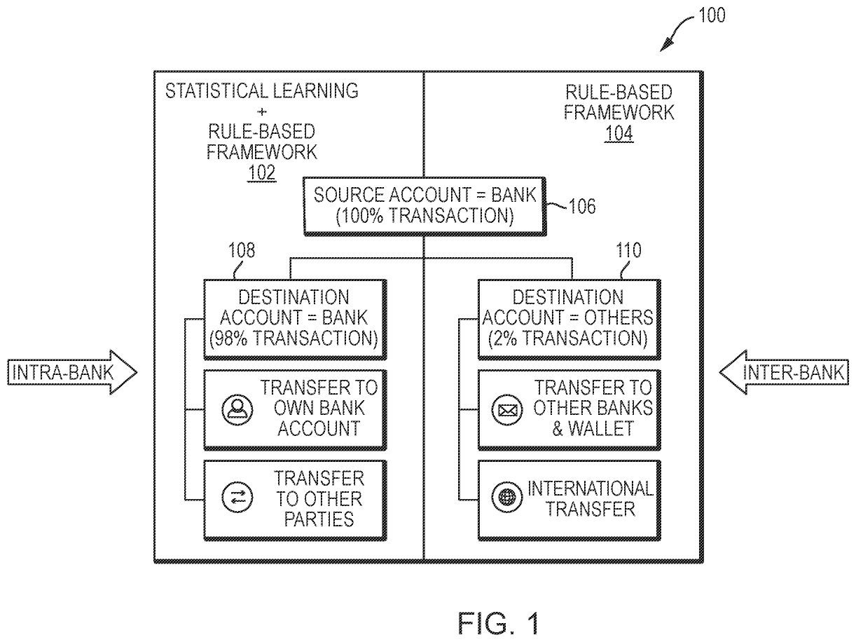

Now, with reference to the figures, FIG. 1 illustrates a layered framework 100 used for intra-bank transfers 102 and inter-bank transfers 104, according to at least one aspect of the present disclosure. As would be known by one having ordinary skill in the art, intra-bank transfers are used when a user is transferring funds from a first account, such as a source account 106, of a first bank, to a second account, such as destination account 108, of the same first bank. In other words, transferring funds from one account to another account within the same bank would be considered an intra-bank transfer. As for inter-bank transfers, they are used when a user is transferring funds from a first account, such as a source account 106, of a first bank, to a second account, such as a destination account 110, of a second bank, or some other location that is different than the first bank. Regardless of the type of transfer, both intra-bank transfers and inter-bank transfers begin at a source account and end at a destination account.

As an example, an intra-bank transfer may include the transfer of funds from a user's first checking account in Bank A to the user's second checking account in Bank A. Alternatively, an intra-bank transfer may include the transfer of funds from a first user's checking account in Bank A to a second user's checking account in Bank A. The only requirement for intra-bank transfers is that the transfer remains within a single bank. Now, looking to the alternative, an inter-bank transfer may include the transfer of funds from a user's checking account in Bank A to the user's checking account in Bank B. Alternatively, an inter-bank transfer may include the transfer of funds from a first user's checking account in Bank A to a second user's checking account in Bank B, which often is the case for international transfers between friends, foreign colleagues, and the like. The only requirement for inter-bank transfers is that the transfer is initiated and operated between different banks. It should be noted that these examples are merely meant to clarify intra-bank transfers and inter-bank transfers, and in no way should be construed as limiting the scope of the present disclosure.

As outlined in FIG. 1, the present disclosure focuses heavily on intra-bank transfers. Specifically, the example set forth in FIG. 1 assumes that 98% of transactions occur within a single bank, meaning that only 2% of transactions occur between different banks. Additionally, intra-bank transfers utilize both a statistical learning model, or probabilistic model as also referred to herein, and a rule-based framework. On the other hand, inter-bank transfers utilize only a rule-based framework. As expected, the statistical learning model leverages customer data in order to accurately detect anomalous activity, while the rule-based framework uses predefined rules to identify cases which match a set of IF-ELSE rules. Both the statistical learning model and the rule-based frameworks will be described in greater detail below when discussing the implementation of the anomaly detection system.

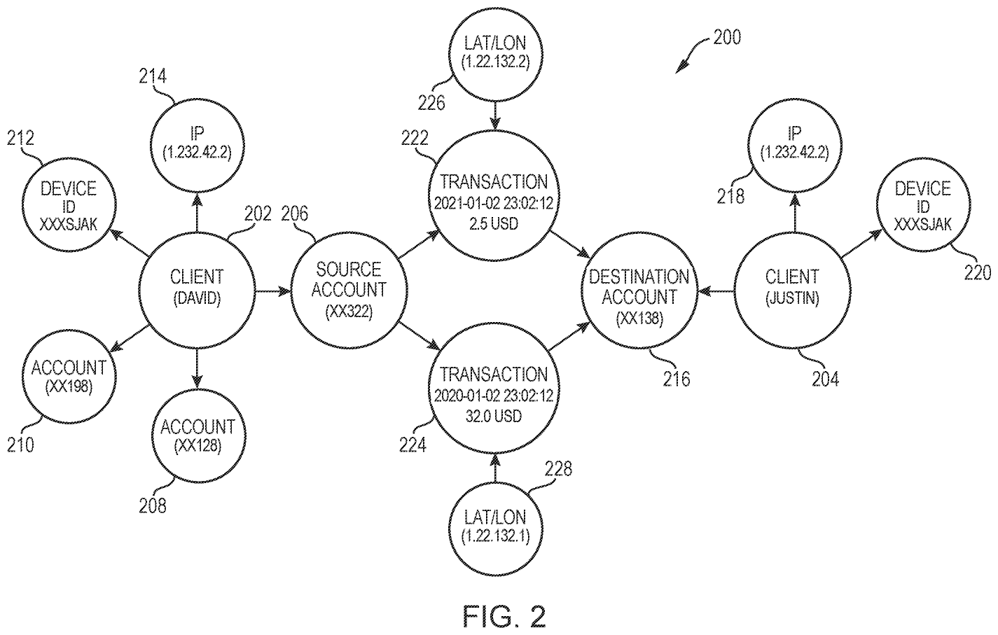

FIG. 2 is a bubble diagram illustrating customer data 200 accessible from an issuer that is used to model behavior for mobile payment fund transfers, according to at least one aspect of the present disclosure. As shown, FIG. 2 illustrates a set of mobile payment transactions between a first client, David, 202 and a second client, Justin, 204. The issuer provides data relating to the first client, David, 202 including different account numbers, such as Source Account 206, Account 208, and Account 210, as well as the Device ID 212 and the IP Address 214 of the first client's payment device at the time of the mobile payment transactions. The issuer also provides data relating to the second client, Justin, 204 including a single account number, the Destination Account 216, as well as the Device ID 218 and the IP Address 220 of the second client's payment device at the time of the mobile payment transactions. The issuer further provides data relating to the mobile payment transactions 222 and 224, including the time (HH:MM:SS), the date (YYYY-MM-DD), and the payment value. In this case, the payment value is listed as the United States dollar (USD) currency, though it should be noted that this currency may be different for other mobile payment transactions. Finally, the issuer provides location-based data 226 and 228, including the latitude and the longitude of the client device that initiates the mobile payment transactions. Altogether, the customer data that is accessible from an issuer can be analyzed and combined together to obtain a complex data set relating to the mobile payment transactions. This includes, but is not limited to, data relating to the features of account related attributes such as account dimension data, account metrics data, and account type data, or data relating to the features of relationship related attributes such as relationship metrics data, and relationship type data. Each of the following groups has been described with greater detail below.

Account Dimension Data. This includes data relating to the account type, the time of day, the day of week, the transaction currency, and the transfer channel for the mobile payment transactions.

Account Metrics Data. This includes data relating to the transaction amount, the transaction count, the ratio of incoming transfers to outgoing transfers, variance between a minimum transfer amount and a maximum transfer amount, recent transaction trends, or a percentage of funds being transferred compared to the funds in the account.

Account Type Data. This includes data relating to whether the account of interest is a source account or a destination account.

Relationship Metrics Data. This includes data relating to the number of days since the first transaction between two or more accounts, the number of days since the last transaction between two or more accounts, the number of transactions in the past one, three, or six months, and the total transaction amount in the past one, three, or six months.

Relationship Type Data. This includes data relating to whether the mobile payment transactions are flowing from the source account to the destination account or from the destination account to the source account.

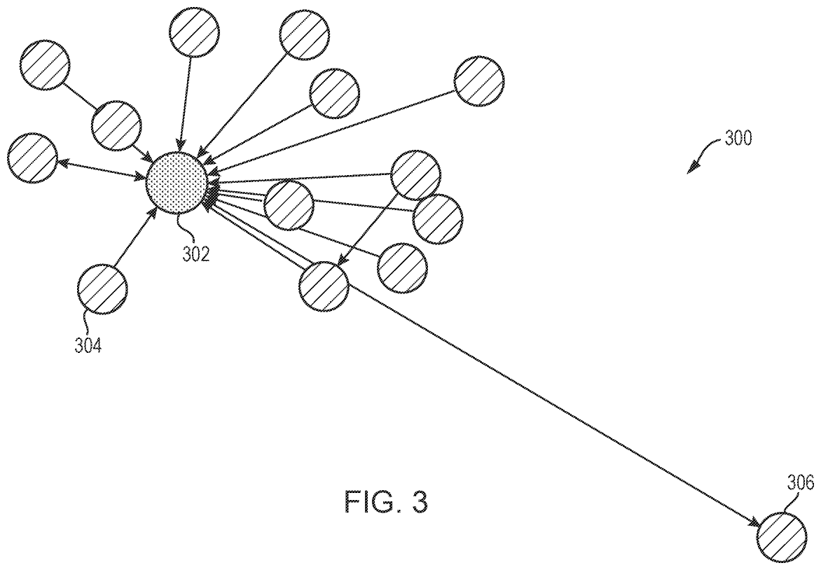

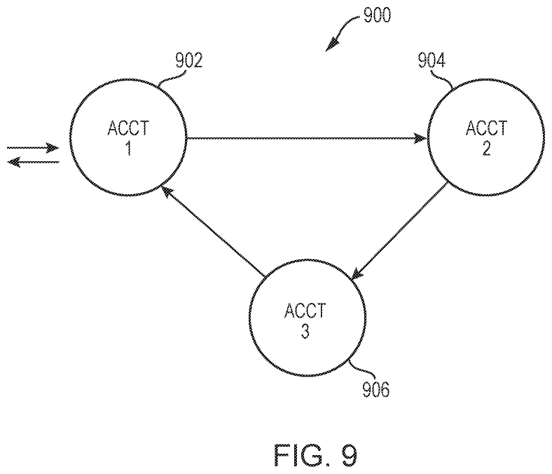

FIG. 3 is an example graph embedding 300 for account-related attributes that projects a source to destination account mobile payment fund transfer flow onto a 3D plane using transaction volume and frequency as properties of the node, according to at least one aspect of the present disclosure. In the graph embedding 300, node 302 represents a destination account 302, while the remaining nodes, such as nodes 304 and 306, represent source accounts 304 and 306. As shown, each node is spatially separated by a defined length from the destination account 302. Although difficult to visualize, the nodes are also spatially separated by a defined degree, either in-degree or out-degree, from the destination account 302. A multitude of factors, such as payment volume and frequency over time, dictate where each node is spatially located with respect to the destination account. For example, source account 304 is spatially located within close proximity to the destination account 302 due to the strength of the relationship between these two accounts. That is, source account 304 and destination account 302 have a strong relationship most likely due to high payment volume and frequency over time. Other source accounts, such as source account 306 are spatially located further away from one another due to a weaker relationship with the destination account 302 when compared with other source accounts such as source account 304. As a result, the mobile payment transaction with source account 306 will be more likely to be considered an anomalous-likely transaction while source account 304 will likely not be considered an anomalous-likely transaction. These embeddings are typically generated and used alongside clustering techniques, which are described in detail below, to better model customer behavior and more accurately detect anomaly-likely transactions. Graph embeddings are also useful for forming triangles which illustrate a relationship between three nodes, or accounts, and illustrate a number of connected components to rank the nodes based on importance. These additional features of graph embeddings will be further discussed below with reference to FIG. 9.

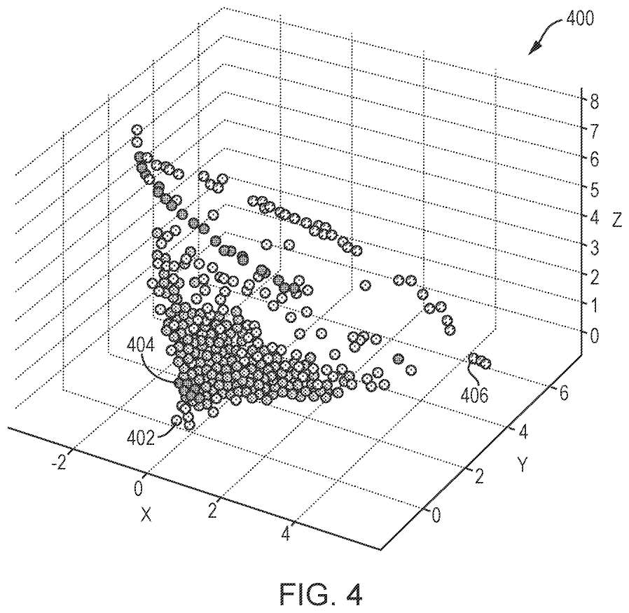

FIG. 4 is an example graph embedding 400 for relationship-related attributes that projects a source to destination account mobile payment fund transfer flow onto a 3D plane using transaction volume and frequency as properties of the node, according to at least one aspect of the present disclosure. The graph embedding of FIG. 4 generally comprises the same principles of the graph embedding of FIG. 3, however there are no arrows depicting a flow of transfer funds from a source account to a destination account, or vice versa. FIG. 4 further illustrates the varying strength of relationships between different accounts. For example, consider the relationship between source account 402 and destination account 404. These nodes are spatially located within close proximity to one another due to the strength of the relationship between these two accounts. That is, source account 402 and destination account 404 have a strong relationship most likely due to high payment volume and frequency over time. Now, for example, consider the relationship between source account 402 and destination account 406. These nodes are spatially located spatially located further away from one another due to a weaker relationship between the source account 402 and the destination account 406. As a result, the mobile payment transaction between source account 402 and destination account 406 will be more likely to be considered an anomalous-likely transaction while the transaction between source account 402 and destination account 406 will likely not be considered an anomalous-likely transaction. As mentioned above, graph embeddings are also useful for forming triangles which illustrate a relationship between three nodes, or accounts, and for illustrate a number of connected components to rank the nodes based on importance. These additional features of graph embeddings will be further discussed below with reference to FIG. 9.

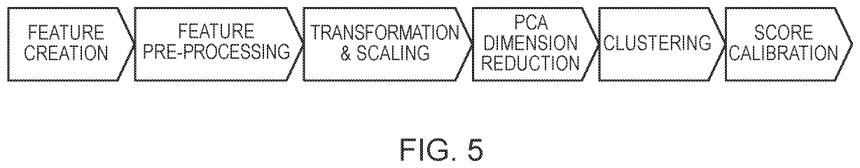

FIG. 5 is a flow diagram showing a typical data science flow for a generative probabilistic model on mobile payment transactions, according to at least one aspect of the present disclosure. Generally speaking, the statistical learning model for mobile payment transactions will follow the steps of feature creation, feature pre-processing, transformation and scaling, PCA dimension reduction, clustering, and score calibration. The steps comprising feature creation, feature pre-processing, transformation and scaling, as well as PCA dimension reduction relate to those features disclosed above with regard to account related attributes such as account dimension data, account metrics data, and account type data, or those features disclosed above with regard to relationship related attributes such as relationship metrics data, and relationship type data. After multiplying and combining the customer data to obtain a complex data set relating to the mobile payment transactions, clustering is performed. Clustering is generally performed using one of a tree-based method or a distance-based method. The tree-based method disclosed herein uses an “Isolation Forest” cluster, while the distance-based method disclosed herein uses one of a “K-Means” or “Gaussian Mixture” cluster. These three cluster types are described in detail below.

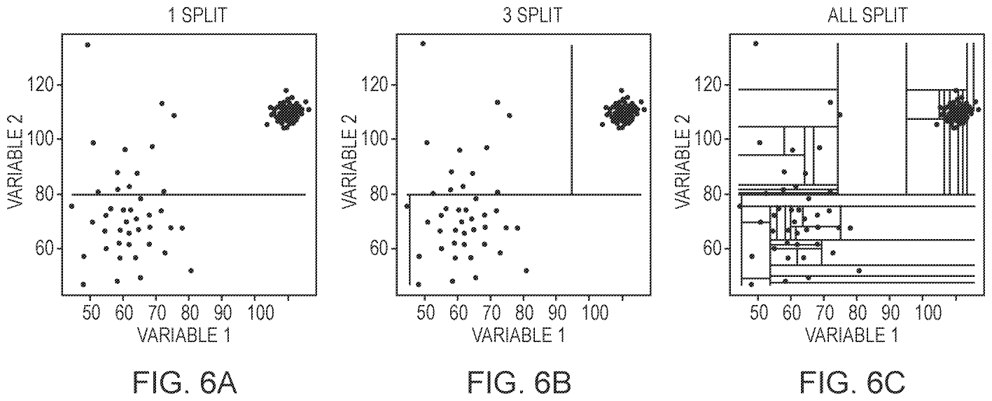

FIGS. 6A-C illustrate an “Isolation Forest” tree-based method to measure how easily points can be separated by randomly splitting the data into smaller regions, according to at least one aspect of the present disclosure. Specifically, FIG. 6A illustrates an “Isolation Forest” cluster with one split, FIG. 6B illustrates an “Isolation Forest” cluster with three splits, and FIG. 6C illustrates an “Isolation Forest” cluster with all splits. Generally speaking, a higher anomaly score is assigned to data points that require fewer splits to be associated. That is, if a data point requires only a few splits to be isolated, then it is likely an outlier and not close by to several other transactions, meaning that it will be assigned a high anomaly score and be associated with an anomalous transaction. On the other hand, if a data point requires a large number of splits to be isolated, then it is likely part of a large cluster and close by to several other transactions, meaning that it will be assigned a low anomaly score and be associated with a regular, or typical, transaction. This disclosed “Isolation Forest” tree-based method is used to contribute to the statistical learning model in order to model customer behavior and more accurately predict anomalous transactions.

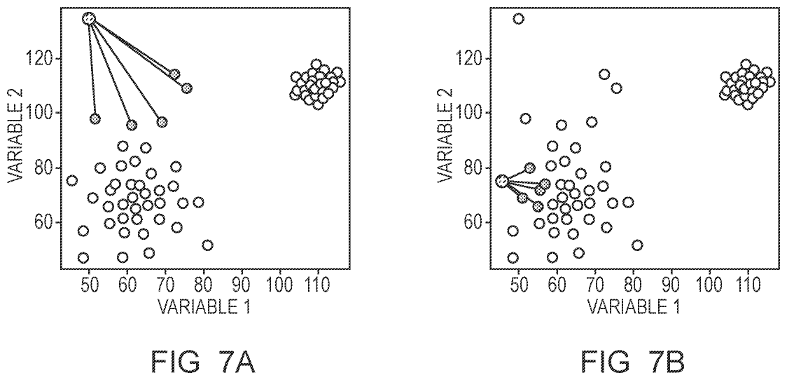

FIGS. 7A-B illustrate a “K-Means” distance-based method to measure how far a point is located from its neighbors and cluster centroids, according to at least one aspect of the present disclosure. Specifically, FIG. 7A illustrates a “K-Means” cluster that highlights a point and the distance to its closest neighbors. Compared to other points in FIG. 7A, the highlighted point is an outlier. FIG. 7B illustrates a “K-Means” cluster as well, however this time the highlighted point is much closer to its closest neighbors than the point highlights in FIG. 7A. Generally speaking, if a data point is far away from its neighbors or the cluster centroids, it will be considered an outlier, given a high anomaly score, and become associated with an anomalous transaction. Thus, in this case, the highlighted data point of FIG. 7A would be assigned a higher anomaly score than the highlighted data point of FIG. 7B. Although, the anomaly score of FIG. 7B would still be higher than a data point in the dense cluster illustrated in the top right of both FIGS. 7A-B. Similar to the aforementioned “Isolation Forest” tree-based method, this “K-Means” distance-based method is used to contribute to the statistical learning model in order to model customer behavior and more accurately predict anomalous transactions.

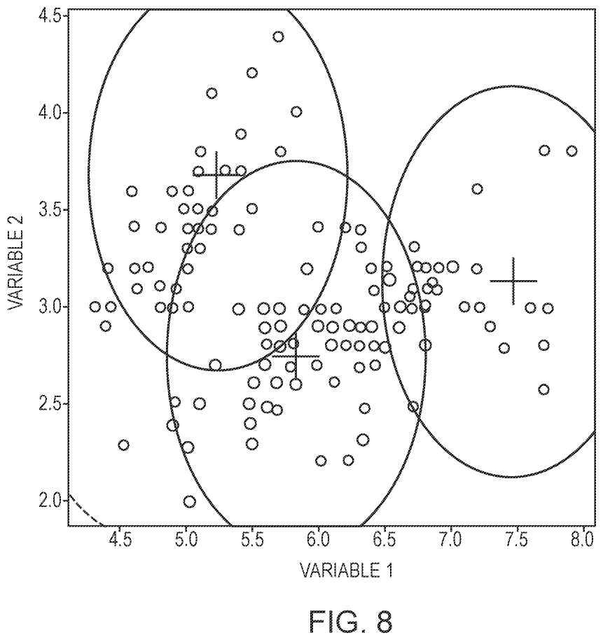

FIG. 8 illustrates a “Gaussian Mixture” distance-based method to measure how far a point is located from its neighbors and cluster centroids, according to at least one aspect of the present disclosure. Unlike FIG. 7, FIG. 8 details a number of clusters whose centroids are identified by a cross in the middle. FIG. 8 illustrates how far certain data points are from their cluster centroid. Similar to FIG. 7, the greater distance will result in a higher anomaly score. In other words, if a data point is far from its cluster centroid, it will obtain a high anomaly score and become associated with an anomalous transaction. However, if a data point is close to its cluster centroid, it will obtain a low anomaly score and become associated with a regular, or typical, transaction. Similar to the aforementioned “Isolation Forest” tree-based method and “K-Means” distance-based method, this “Gaussian Mixture” distance-based method is used to contribute to the statistical learning model in order to model customer behavior and more accurately predict anomalous transactions.

FIG. 9 illustrates a sample group from a graph embedding 900 that includes a first account 902, a second account 904, and a third account 906, according to at least one aspect of the present disclosure. In this figure, a triangles formation is show which illustrates a relationship between three nodes, or three different accounts: Account 1 902, Account 2 904, and Account 3 906. Additionally, this figure illustrates the number of connected components and the number connections at each node, or account. In this case, Account 1 902 interacts with Account 2 904. Account 2 904 interacts with Account 3 906. Account 3 906 interacts with Account 1 902. Additionally, Account 1 902 interacts with, and is interacted with, by an undisclosed account. Finally, FIG. 9 illustrates the importance of various nodes and ranking them accordingly. Although not ranked in FIG. 9, it is expected that the node of Account 1 902 is the most important due to the highest number of interactions. Then, the nodes of Account 2 904 and Account 3 906 are equivalent in this case as they have an equal number of interactions. However, it should be noted that in a typical setting, there will be far more complex interactions making the ranking of nodes based on importance more prevalent, and not as simple as the ranking of those shown in FIG. 9. Similar to the aforementioned tree-based method and distance-based methods, graph embeddings are also used to contribute to the statistical learning model in order to model customer behavior and more accurately predict anomalous transactions.

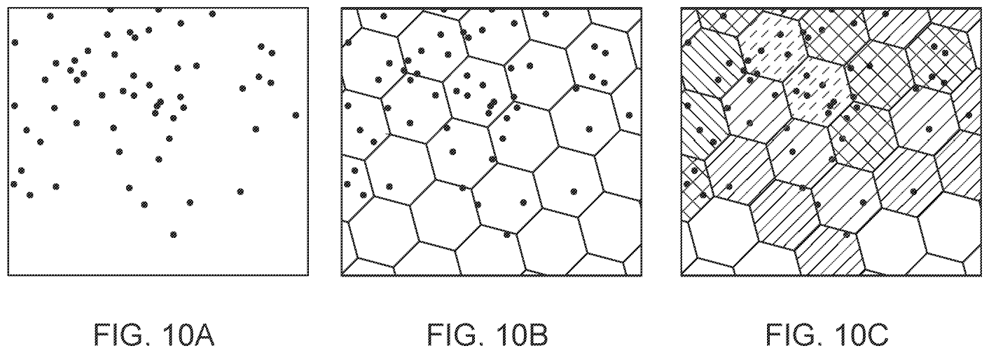

FIGS. 10A-C illustrate a geo-spatial mapping of payment device locations at the time of a transaction in order to create hex grids and model customer behavior for regular and irregular mobile payment transactions, according to at least one aspect of the present disclosure. For clarity purposes, the background illustrating roads, highways, trails, and the like has been removed from each of FIGS. 10A-C. It should be noted, however, that the geo-spatial mapping may illustrate a bigger area than just roads, highways, trails, and the like. Specifically, the geo-spatial mapping may illustrate states, countries, and the like. Now, with reference to each of FIGS. 10A-C. FIG. 10A illustrates a geo-spatial mapping which has marked several locations where a payment device was located at the time of different mobile payment transactions. When looking at FIG. 10B, the same map is shown, however, FIG. 10B introduces a hex grid on the map which identifies how many mobile payment transactions occur within a given area, or hexagon. This illustrates where the most, or the least, mobile payment transactions occur on the map. Finally, when looking at FIG. 10C, the hexagons are shaded different colors to indicate high mobile payment transaction activity or low mobile payment transaction activity. Altogether, the data gathered in FIGS. 10A-C helps to model customer behavior by determining potential locations for regular, or typical, transactions and by determining potential locations for irregular, or anomalous, transactions. In the case of regular, or typical, transactions there will be a high frequency of transactions in a given area. In the case of irregular, or anomalous, transactions there will be a low frequency of transactions in a given area. Similar to the above tree-based method, distance-based methods, and graph embeddings, the geo-spatial mapping disclosed herein contributes to the statistical learning model in order to model customer behavior and more accurately predict anomalous transactions.

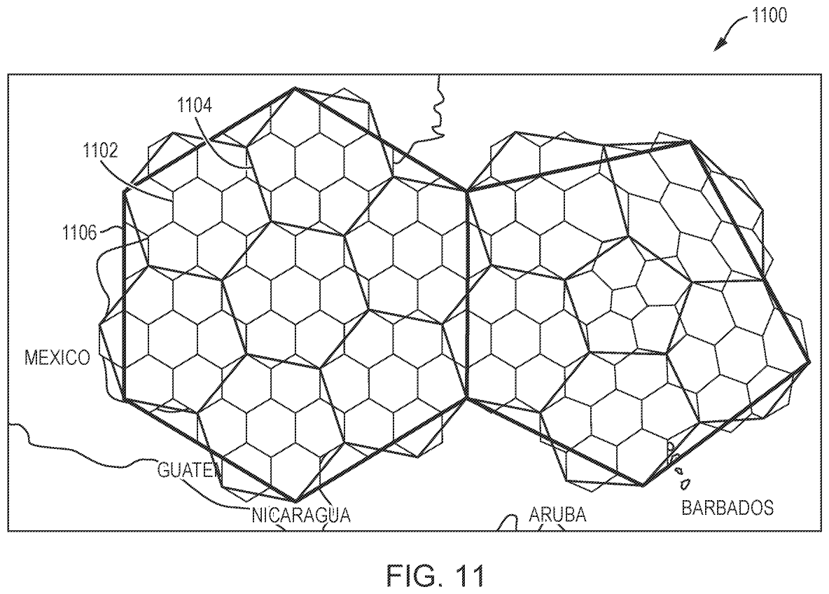

FIG. 11 illustrates different levels of resolution for hexagon and pentagon grids 1100 created during a geo-spatial mapping of payment device locations at the time of different mobile payment transactions, according to at least one aspect of the present disclosure. Hexagon 1102, and all similar-sized hexagons as shown in FIG. 11, directly correlates to the smallest average hexagon area per km². As shown, around seven hexagons the size of hexagon 1102 can be put together to form hexagon 1104 which includes a greater average hexagon area per km² than hexagon 1102. Finally, around seven hexagons the size of hexagon 1104 can be put together to form hexagon 1106 which has the largest average hexagon area per km². Altogether, these hexagons and various resolutions help gather customer data for a variety of areas, from large to small, in order to model customer behavior for potential locations for regular, or typical, transactions versus irregular, or anomalous, transactions. Along with the aforementioned geo-spatial mapping disclosed above, the use of various resolutions for geo-spatial mapping contributes to the statistical learning model in order to model customer behavior and more accurately predict anomalous transactions.

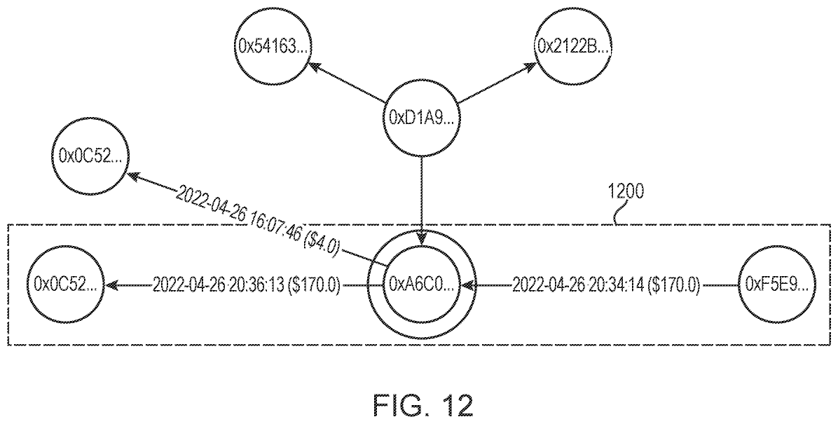

FIG. 12 illustrates a potential anomalous transaction pattern 1200, such as receiving a fund and immediately transferring the same amount, using a graph visualization tool, Neo4J, according to at least one aspect of the present disclosure. Specifically, in this case, an account receives 170.00 USD and immediately transfers the same amount, 170.00 USD, to another account. The receiving and sending of the same amount from one account to another account is known to be a potential anomalous transaction pattern and thus raises a concern that anomalous activity is occurring within this customer(s) account(s).

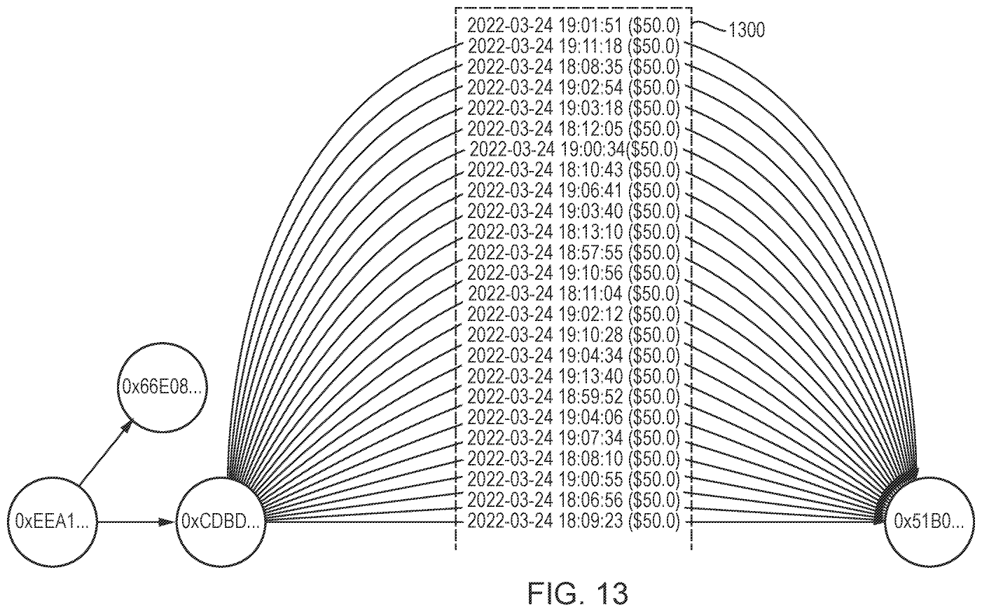

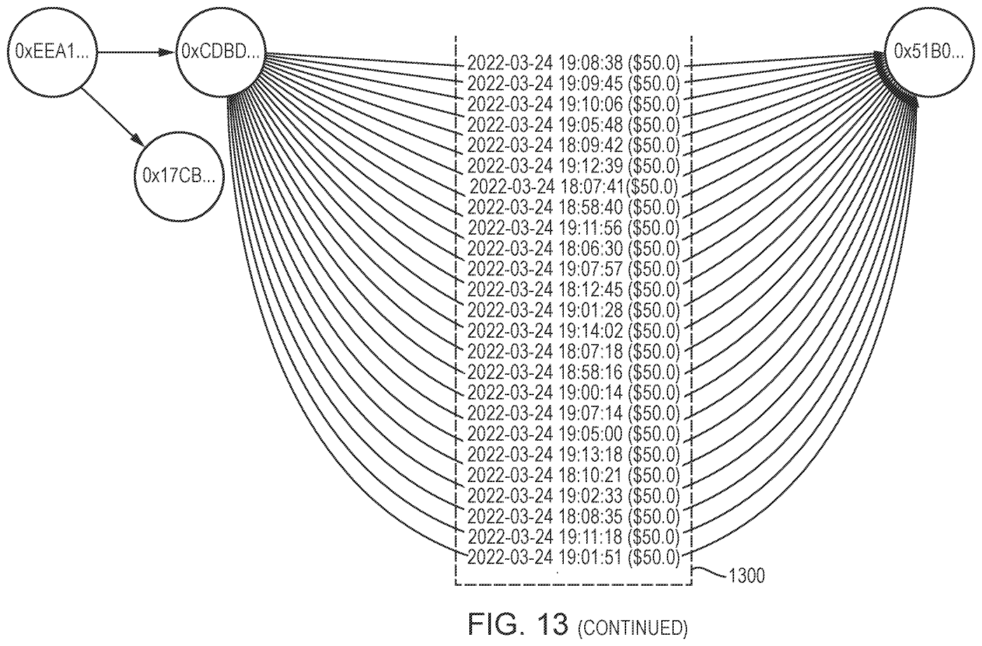

FIG. 13 illustrates a potential anomalous transaction pattern 1300, such as repeated ticket size transfer to the same account within a short period of time, using a graph visualization tool, Neo4J, according to at least one aspect of the present disclosure. Specifically, in this case, an account transferred the same amount, 50.00 USD, repeatedly several times within a short period of time. The sending of a fixed amount several times within a short period of time is known to be a potential anomalous transaction pattern and thus raises a concern that anomalous activity is occurring within this customer(s) account(s).

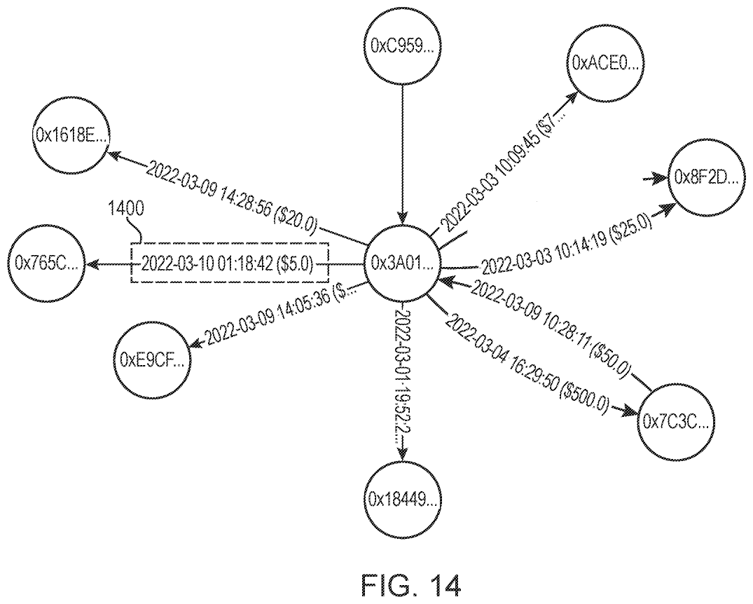

FIG. 14 illustrates a potential anomalous transaction pattern 1400, such as transaction activity during unusual hours during mid-night, using a graph visualization tool, Neo4J, according to at least one aspect of the present disclosure. Specifically, in this case, a number of regular, or typical, transactions occur between 10:00 and 16:30. However, there was a single transfer that occurred during the mid-night which is known to be a potential anomalous transaction pattern and thus raises a concern that anomalous activity is occurring within this customer(s) account(s).

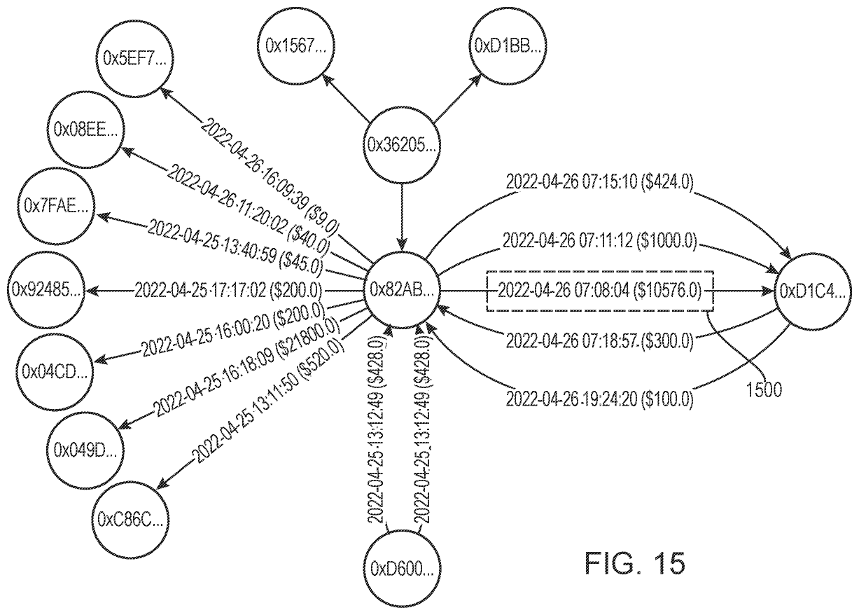

FIG. 15 illustrates a potential anomalous transaction pattern, such as higher than usual ticket size from the same account, using a graph visualization tool, Neo4J, according to at least one aspect of the present disclosure. Specifically, in this case, one account has been making several transfers of value ranging between 100.00 USD and 1,000.00 USD. However, a transfer was suddenly made with a value of 10,576.00 USD. This is known to be a potential anomalous transaction pattern and thus raises a concern that anomalous activity is occurring within this customer(s) account(s).

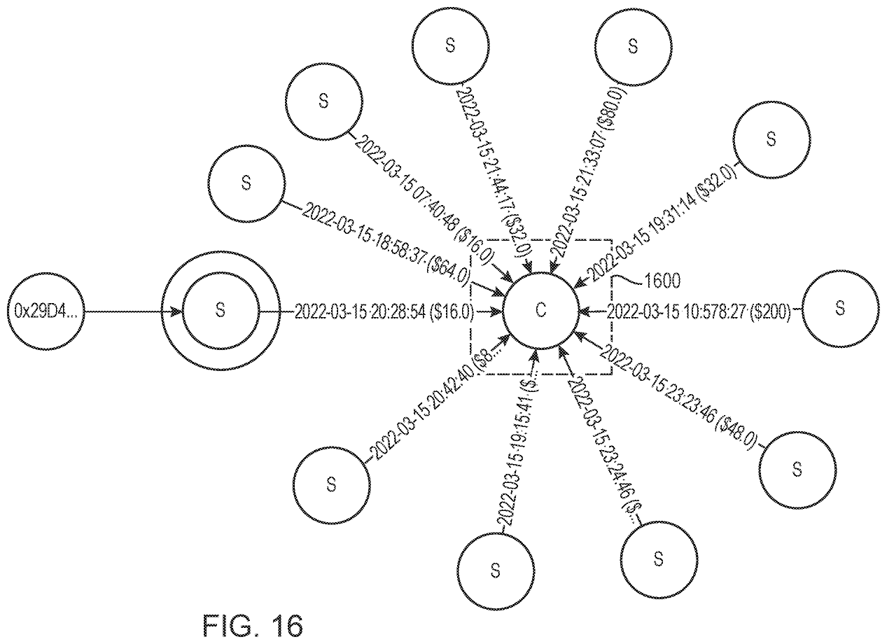

FIG. 16 illustrates a potential anomalous transaction pattern, such as a destination account receiving funds from multiple different accounts in a short period of time, using a graph visualization tool, Neo4J, according to at least one aspect of the present disclosure. Specifically, in this case, an account has received a transfer from eleven different accounts in a short period of time. This is known to be a potential anomalous transaction pattern and thus raises a concern that anomalous activity is occurring within this customer(s) account(s).

The graph visualization tool, Neo4J, listed above in FIGS. 12-16 contributes to the statistical learning model in order to model customer behavior and more accurately predict anomalous transactions. Altogether, all of the features outlined above such as graph embeddings, an “Isolation Forest” tree-based method, a “K-Means” or “Gaussian Mixture” distance-based method, a geo-spatial mapping, and a graph visualization using Neo4J work together to provide a comprehensive data set that more accurately predicts anomalous transaction activity within a customer(s) account(s).

Furthermore, with respect to each of FIGS. 12-16, the account number, transaction date, transaction time, transaction amount, and the like are merely meant to illustrate potential anomalous transaction patterns. That is, each of the account numbers, transaction dates, transaction times, transaction amounts, and the like, as shown in FIGS. 12-16, are not so limiting.

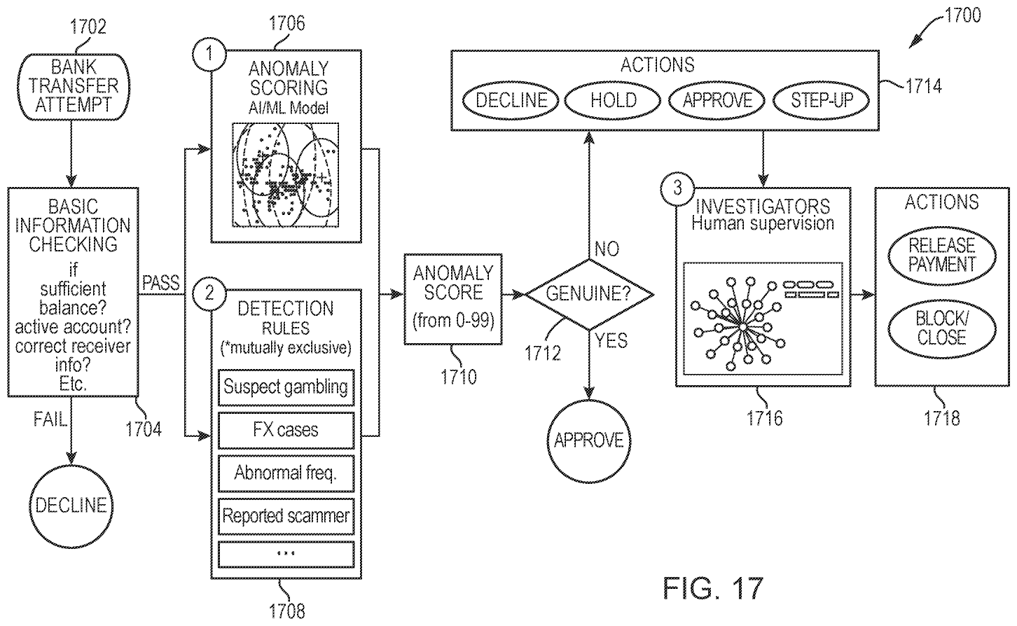

FIG. 17 illustrates an implementation of the anomaly detection system 1700 using a three-layer framework, according to at least one aspect of the present disclosure. When implemented, the anomaly detection system generally begins with a bank transfer attempt 1702 which results in a step 1704 performing basic information checking. If declined, the mobile payment transaction is declined and the process ends. If passed, the bank transfer attempt 1702 advances to a scoring layer 1706 of the three-layer framework to perform an artificial intelligence (AI)/machine learning (ML) clustering model to determine a mobile payment transaction anomaly score based on account behaviors. The bank transfer attempt 1702 also advances to a rule layer 1708 of the three-layer framework to perform IF-ELSE logic to identify defined anomalous cases. Altogether, the scoring layer and the rule layer formulate an anomaly score 1710 between 0 and 99. Next, the anomaly score 1710 advances to a step 1712 to determine if the score is genuine. If the score is genuine, the mobile payment transaction is approved and the process ends. However, if the score is not genuine, the anomaly score 1710 advances to have an action 1714 taken, which is either declining the mobile payment transaction, holding the mobile payment transaction, approving the mobile payment transaction, or stepping-up the mobile payment transaction. After an action 1714 is determined, an investigation layer 1716 of the three-layer framework performs an investigation on anomaly-likely cases using a graph visualization tool, such as Neo4J. An output includes the anomalous and non-anomalous cases, which are sent to have an action 1718 taken, which is either releasing payment or blocking/ceasing payment. After payment has been released, or payment has been blocked/ceased, the process is complete and the anomaly detection system for mobile payment transactions has successfully implemented risk measures to reduce anomalous activity in mobile banking transactions.

Although the three-layer framework disclosed above details a scoring layer, a rule layer, and an investigation layer, the three-layer framework may be alternatively disclosed as encompassing a statistical model, or probabilistic model, that is equivalent to the scoring layer, a rule-based method equivalent to the rule layer, and a decision engine layer equivalent to the investigation layer. In all cases, these three layers perform substantially the same operation to assist in determining if a bank transfer amount is likely to be an anomalous transaction or a non-anomalous transaction.

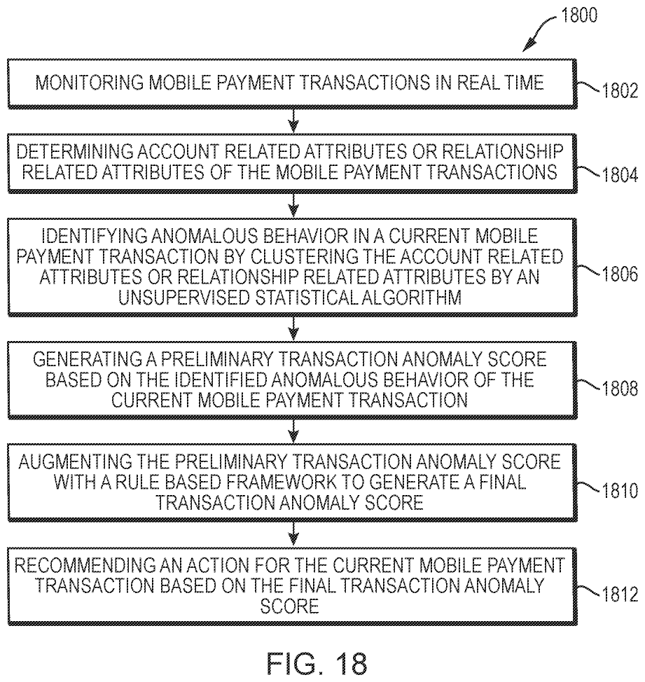

FIG. 18 illustrates a method for detecting anomalies in mobile payment transactions, according to at least one aspect of the present disclosure. The disclosed method is a processor-implemented method comprising the following steps: monitoring mobile payment transactions in real time; determining account related attributes or relationship related attributes of the mobile payment transactions, identifying anomalous behavior in a current mobile payment transaction by clustering the account related attributes or relationship related attributes by an unsupervised statistical algorithm; generating a preliminary transaction anomaly score based on the identified anomalous behavior of the current mobile payment transaction; augmenting the preliminary transaction anomaly score with a rule based framework to generate a final transaction anomaly score; and recommending an action for the current mobile payment transaction based on the final transaction anomaly score. In addition to the steps outlined above, additional steps may be added to the processor-implemented method to better detect anomalies in mobile payment transactions and to accurately recommend an action for the current mobile payment transaction based on the final transaction anomaly score.

In order to operate and execute the processes associated with detecting anomalies in mobile payment transactions in each of the systems and methods disclosed herein, a number of technologies may be used. This may include the use of at least one of a computer apparatus or a host machine, which are further disclosed below. That is, a computer apparatus and/or a host machine, as disclosed below, may be used in any of the aforementioned systems or methods for detecting anomalies in mobile payment transactions.

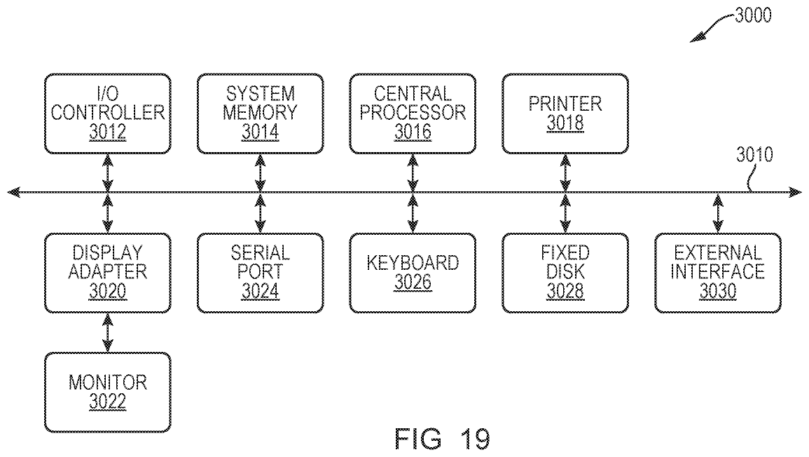

FIG. 19 is a block diagram of a computer apparatus 3000 with data processing subsystems or components, according to at least one aspect of the present disclosure. The subsystems shown in FIG. 19 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

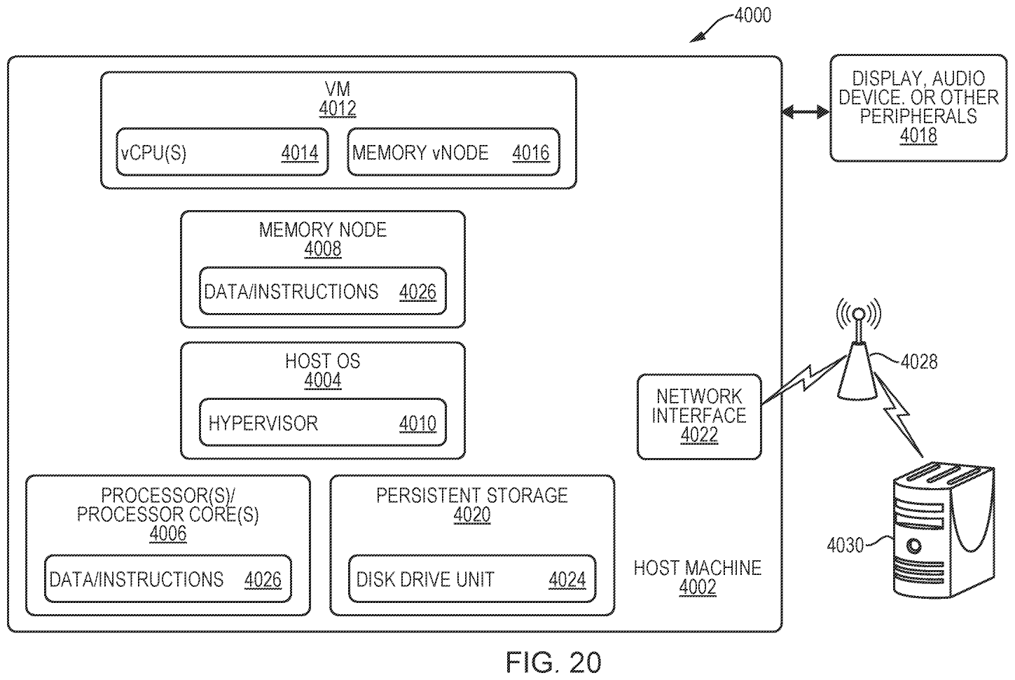

FIG. 20 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A system for detecting anomalies in mobile payment transactions, the system comprising:
a server computer comprising a processor and a memory coupled to the processor, the memory storing thereon machine executable instructions that when executed cause the processor to:
monitor mobile payment transactions in real-time;
determine account related attributes or relationship related attributes of the mobile payment transactions;
identify anomalous behavior in a current mobile payment transaction by clustering the account related attributes or relationship related attributes by an unsupervised statistical algorithm;
generate a preliminary transaction anomaly score based on the identified anomalous behavior of the current mobile payment transaction;
augment the preliminary transaction anomaly score with a rule-based framework to generate a final transaction anomaly score; and
recommend an action for the current mobile payment transaction based on the final transaction anomaly score.

2. The system of claim 1, wherein the unsupervised statistical algorithm combines account dimension data, account metrics data, and account type data to obtain a comprehensive data set relating to the account related attributes,
wherein the account dimension data includes information relating to at least one of an account type, transaction time, transaction date, transaction currency, or a transfer channel;
wherein the account metrics data includes information relating to at least one of a transaction amount, transaction count, ratio of incoming transfers to outgoing transfers, variance between a minimum transfer amount and a maximum transfer amount, recent transaction trends, or a percentage of funds being transferred; and
wherein the account type data includes information relating to at least one of a source account or a destination account.

3. The system of claim 1, wherein the unsupervised statistical algorithm combines relationship metrics data and relationship type data to obtain a comprehensive data set relating to the relationship related attributes,
wherein the relationship metrics data includes information relating to at least one of a number of days since a first transaction, a number of days since a last transaction, a number of transactions in a previous month, a number of transactions in a previous three months, a number of transactions in a previous six months, a total transaction amount in the previous month, a total transaction amount in the previous three months, and a total transaction amount in the previous six months; and
wherein relationship type data includes information relating to at least one of a source account or a destination account.

4. The system of claim 1, wherein the identified anomalous behavior is at least one of a fraudulent activity, client abuse activity, or potential laundering activity.

5. The system of claim 1, wherein the system further comprises a three-layer framework comprising:
a probabilistic model to generate the preliminary transaction anomaly score;
a rule-based framework used to augment the preliminary transaction anomaly score according to recent market and portfolio fraud trends; and
a decision engine to approve, refer, or decline the mobile payment transactions based on a comparison between the final transaction anomaly score and a scoring threshold.

6. The system of claim 5, wherein both the probabilistic model and the rule-based framework are used for intrabank transfers, and wherein only the rule-based framework is used for interbank transfers.

7. The system of claim 1, wherein customer data from an issuer is used to more accurately model behavior for regular transfers and anomalous transfers.

8. The system of claim 1, wherein a graph visualization tool is used to investigate high score transactions and create a feedback loop for fine tuning the system.

9. The system of claim 1, wherein graph embeddings are used to project mobile payment transactions onto a 3D plane, and wherein transaction volume and transaction frequency are properties of each node of the graph embeddings.

10. The system of claim 7, wherein a location of a payment device is geo-spatially mapped onto a map to create grids over time that model customer behavior for regular transfers and anomalous transfers.

11. A processor-implemented method for detecting anomalies in mobile payment transactions, the method comprising:
monitoring mobile payment transactions in real-time;
determining account related attributes or relationship related attributes of the mobile payment transactions;
identifying anomalous behavior in a current mobile payment transaction by clustering the account related attributes or relationship related attributes by an unsupervised statistical algorithm;
generating a preliminary transaction anomaly score based on the identified anomalous behavior of the current mobile payment transaction;
augmenting the preliminary transaction anomaly score with a rule-based framework to generate a final transaction anomaly score; and
recommending an action for the current mobile payment transaction based on the final transaction anomaly score.

12. The processor-implemented of claim 11, wherein the unsupervised statistical algorithm combines account dimension data, account metrics data, and account type data to obtain a comprehensive data set relating to the account related attributes,
wherein the account dimension data includes information relating to at least one of an account type, transaction time, transaction date, transaction currency, or a transfer channel;
wherein the account metrics data includes information relating to at least one of a transaction amount, transaction count, ratio of incoming transfers to outgoing transfers, variance between a minimum transfer amount and a maximum transfer amount, recent transaction trends, or a percentage of funds being transferred; and
wherein the account type data includes information relating to at least one of a source account or a destination account.

13. The processor-implemented of claim 11, wherein the unsupervised statistical algorithm combines relationship metrics data and relationship type data to obtain a comprehensive data set relating to the relationship related attributes,
wherein the relationship metrics data includes information relating to at least one of a number of days since a first transaction, a number of days since a last transaction, a number of transactions in a previous month, a number of transactions in a previous three months, a number of transactions in a previous six months, a total transaction amount in the previous month, a total transaction amount in the previous three months, and a total transaction amount in the previous six months; and
wherein relationship type data includes information relating to at least one of a source account or a destination account.

14. The processor-implemented of claim 11, wherein the identified anomalous behavior is at least one of a fraudulent activity, client abuse activity, or potential laundering activity.

15. The processor-implemented of claim 11, wherein the method further comprises using a three-layer framework comprising:
a probabilistic model to generate the preliminary transaction anomaly score;
a rule-based framework used to augment the preliminary transaction anomaly score according to recent market and portfolio fraud trends; and
a decision engine to approve, refer, or decline the mobile payment transactions based on a comparison between the final transaction anomaly score and a scoring threshold.

16. The processor-implemented of claim 15, wherein both the probabilistic model and the rule-based framework are used for intrabank transfers, and wherein only the rule-based framework is used for interbank transfers.

17. The processor-implemented of claim 11, wherein customer data from an issuer is used to more accurately model behavior for regular transfers and anomalous transfers.

18. The processor-implemented of claim 11, wherein a graph visualization tool is used to investigate high score transactions and create a feedback loop for fine tuning a system.

19. The processor-implemented of claim 11, wherein graph embeddings are used to project mobile payment transactions onto a 3D plane, and wherein transaction volume and transaction frequency are properties of each node of the graph embeddings.

20. The processor-implemented of claim 17, wherein a location of a payment device is geo-spatially mapped onto a map to create grids over time that model customer behavior for regular transfers and anomalous transfers.
